(19) United States
(12) Patent Application Publication
(10) Pub. No.: US 2024/0267236 A1
(43) Pub. Date: Aug. 8, 2024

(54) Method for Integrating a New Component Into a Network, Registration Component, and System

(71) Applicant: Siemens Aktiengesellschaft, München (DE)

(72) Inventors: Andreas Furch, Freising (DE); Oliver Pfaff, Berlin (DE)

(73) Assignee: Siemens Aktiengesellschaft, München (DE)

(21) Appl. No.: 18/565,124

(22) PCT Filed: May 10, 2022
(86) PCT No.: PCT/EP2022/062647

§ 371 Date: Nov. 29, 2023

(30) Foreign Application Priority Data
May 31, 2021 (DE) 10 2021 205 549.4
Sep. 22, 2021 (EP) 21198331.7

(51) Int. Cl. H04L 9/32

(52) U.S. Cl. CPC H04L 9/3268

(57) ABSTRACT

Some embodiments of the teachings herein include a method for integrating a new component with a device certificate of a domain with a domain root certificate into a network with at least one existing component with an existing device certificate of the domain. An example method includes: accepting a request from the new component signed with the device certificate of the domain; determining the existing component with the existing device certificate transmitting the request to the existing component; verifying the device certificate using the domain root certificate of the domain; providing a response signed with the existing device certificate and provided with a network certificate using the existing component or obtaining a response signed with the existing device certificate and provided with a network certificate from the existing component; transmitting the response to the new component; and integrating the new component into the network using the network certificate.

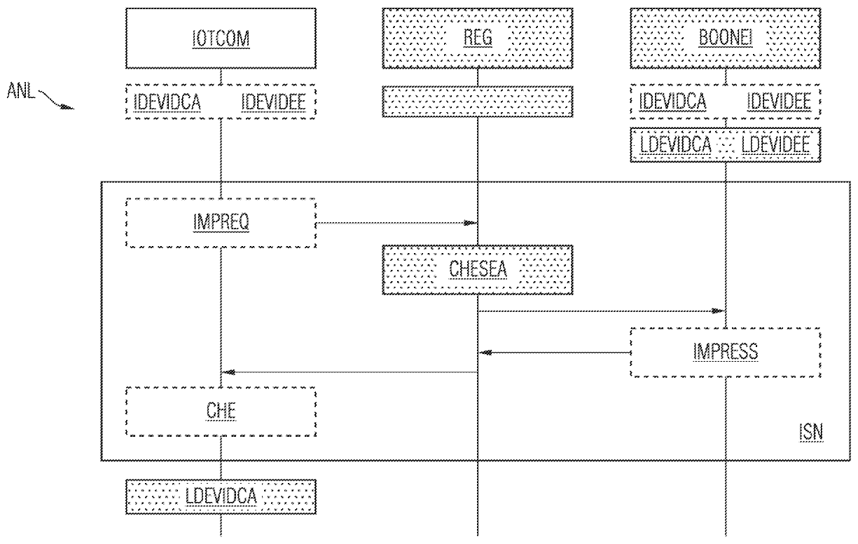

### CROSS-REFERENCE TO RELATED APPLICATIONS

This application U.S. National Stage Application of International Application No. PCT/EP2022/062647 filed May 10, 2022, which designates the United States of America, and claims priority to EP Application No. 21198331.7 filed on Sep. 22, 2021 and DE Application No. 10 2021 205 549.4 filed May 31, 2021, the contents of which are hereby incorporated by reference in their entirety.

### TECHNICAL FIELD

The present disclosure relates to networks. Various embodiments of the teachings herein include methods and/or systems for integrating a new component with a device certificate of a domain into a network.

### BACKGROUND

The communication of Internet of Things (IoT) devices is often secured using cryptographic keys and associated certificates. As a rule, key pairs comprise a private key and a public key. Such key pairs enable encrypted and authenticated communication using asymmetric cryptographic methods. The public key of a key pair is usually linked in an authenticated and integrity-protected manner by means of a so-called public key infrastructure (PKI) using a certificate with identity information to be ensured beforehand. A unique certificate forms the self-signed root certificate of such a PKI. This serves as the trust anchor of such a system of Internet of Things devices, especially within a specific system.

This root certificate must be communicated to all participants in the PKI in a trustworthy manner so that all participants in the PKI can trust the root certificate. The introduction of such root certificates is therefore a critical process for Internet of Things networks, as the root certificates determine whether Internet of Things devices can be considered authenticated. An Internet of Things device therefore requires a network-specific root certificate, a network-specific terminal device certificate and associated private keys for secure communication in the network.

An Internet of Things device whose communication is to be protected by means of such a PKI can in principle obtain certificates and keys, hereinafter also referred to as credentials, in many different ways. For the trusted integration of an Internet of Things device into a network, the Internet of Things device must be provided with the root certificate or a public key contained in the root certificate or a unique and secure reference to the root certificate or a key contained in the root certificate in order to be able to derive therefrom the trustworthiness of other Internet of Things devices at a later time. When transferring the root certificate to such an Internet of Things device, so-called imprinting methods are used, which are a security-critical and therefore high-risk process in the management of Internet of Things networks with Internet of Things devices.

It is known to transfer root certificates to Internet of Things devices manually, i.e. by hand. However, for Internet of Things networks of a certain size, this is complex and expensive to implement. It is also known to transfer network-specific root certificates to Internet of Things devices using automatic methods with or without organizational security. However, this may lead to security risks. There are also automatic methods with security mechanisms that can be used for such imprinting, such as the Bootstrapping Remote Secure Key Infrastructures (BRSKI) method. However, such automatic methods with security mechanisms require new services or system components, such as manufacturer-authorized signing authorities or other authorities.

### SUMMARY

The teachings of the present disclosure include improved methods and/or systems for integrating new components into a network. In particular, such a new method should make it easy to add network-specific root certificates to the new component. Some embodiments include registration components by which a new component can be integrated into a network efficiently, cost-effectively, and securely. Some embodiments include systems with a network in which new components can be integrated into the system's network easily and cost-effectively and at the same time securely.

For example, some embodiments include a method for integrating a new component (IOTCOM) into a network (ISN), wherein a new component (IOTCOM) with a device certificate (IDEVIDEE) of a domain with a domain root certificate (IDEVIDCA) and a network with at least one existing component (BOONEI), which has an existing device certificate of the domain, are used, and in which a request (IMPREQ) from the new component (IOTCOM) signed with the device certificate (IDEVIDEE) of the domain is accepted and the existing component (BOONEI) is determined with the existing device certificate and the request (IOMPREQ) is transmitted to the existing component (BOONEI), wherein the device certificate (IDEVIDEE) is verified using the domain root certificate (IDEVIDCA) of the domain, and wherein a response (IMPRES) signed with the existing device certificate and provided with a network certificate (LDEVIDCA) is provided by means of the existing component (BOONEI) or a response (IMPRES) signed with the existing device certificate and provided with a network certificate (LDEVIDCA) is obtained from the existing component (BOONEI), which response is transmitted to the new component (IOTCOM) and the new component (IOTCOM) is integrated into the network (ISN) using the network certificate (LDEVIDCA).

In some embodiments, the network certificate (LDEVIDCA) is a root certificate of the network (ISN).

In some embodiments, the domain root certificate is a root certificate of the device certificate (IDEVIDEE) and the existing device certificate.

In some embodiments, the method is carried out by a registration component (REG).

In some embodiments, the registration component (REG) is not part of the network (ISN) and is configured for communication with components of the network (ISN).

In some embodiments, the registration component (REG) maintains a trust relationship with the existing component (BOONEI).

In some embodiments, the network (ISN) is a part of a system (ANL) in the form of a manufacturing system or a processing system or a vehicle or a machine.

In some embodiments, the network (ISN) is an Internet of Things network.

In some embodiments, device certificate (IDEVIDEE) and existing device certificate and network certificate (LDEVIDCA) are each certificates comprising a public key part of an asymmetric cryptographic key pair.

As another example, some embodiments include a registration component, designed to carry out a method as described herein, and configured to integrate a new component (IOTCOM) having a device certificate (IDEVIDEE) of a domain with a domain root certificate (IDEVIDCA) into a network (ISN) with at least one existing component (BOONEI) having an existing device certificate of the domain, which, in particular for executing method steps of the method, is configured to receive a request (IMPREQ) from the component (IOTCOM) signed with the device certificate (IDEVIDEE) of the domain and to determine the existing component (BOONEI) with the existing device certificate and to transmit the request (IMPREQ) from the component (IOTCOM) to the existing component (BOONEI), and which is configured to receive a response from the existing component (BOONEI) signed with the existing device certificate and provided with a network certificate (LDEVIDCA) and to transmit the response to the new component (IOTCOM).

In some embodiments, the registration component is designed to verify the device certificate (IDVIDEE) of the new component (IOTCOM) using the domain root certificate (IDEVIDCA).

In some embodiments, the registration component is an Internet of Things device.

As another example, some embodiments include a system with a network (ISN), in particular an Internet of Things network, and with a registration component (REG) as described herein.

### BRIEF DESCRIPTION OF THE DRAWING

The disclosure is explained in more detail below with reference to an exemplary embodiment shown in the drawing. The sole FIGURE in the drawing, shows, schematically in a principle sketch, an implementation of an example method incorporating teachings of the present disclosure using a registration component of a system with an Internet of Things network.

### DETAILED DESCRIPTION

In an example method for integrating a new component into a network, a new component with a device certificate of a domain with a domain root certificate is used. In some embodiments, the domain is the manufacturer domain of a manufacturer of the new component. In addition, the method uses a network that comprises at least one existing component that has an existing device certificate of the domain. A request from the new component is accepted, said request being signed with the device certificate, i.e. signed with a private key belonging to the device certificate of the domain, and may be subjected to a check and the existing component with the existing device certificate is determined, e.g. after the check has been carried out.

The request is transmitted to the existing component, wherein the device certificate is verified using the domain root certificate of the domain, and wherein a response signed with the existing device certificate, signed with a private key belonging to the existing device certificate, and provided with a network certificate, e.g. a root certificate of the network, is provided by means of the existing component, which response is transmitted to the new component. The new component is integrated into the network using the network certificate. In some embodiments, instead of the method step that a response signed with the existing device certificate, signed with a private key corresponding to the existing device certificate, and provided with a network certificate, e.g. a root certificate of the network, is provided by the existing component, the method step can be provided that a response signed with the existing device certificate, signed with a private key corresponding to the existing device certificate, and provided with a network certificate is obtained from the existing component. The existing component is expediently instructed or prompted, in particular requested and/or triggered, to provide the response signed the existing device certificate, e.g. signed with a private key belonging to the existing device certificate.

The phrase “a response is obtained from the existing component” means that a response sent by the existing component is obtained, e.g. received or accepted. The response sent by the existing component is therefore obtained or received.

In some embodiments, a manufacturer domain of the new component acts as a domain that establishes a trust relationship between the new component and the existing component. A network certificate, in particular a root certificate of the network, can then be transmitted in a trustworthy manner via this trust relationship.

In some embodiments, the at least one existing component has both the device certificate of the domain and the network certificate of the network. In this development, the existing component can therefore sign both with the network certificate, with a private key belonging to the network certificate, and with the existing device certificate, with a private key belonging to the existing device certificate.

It is understood that the phrase “signed with a certificate” in the context of the present disclosure always means signed with a private key belonging to the certificate. In particular, the device certificate or the existing device certificate or the network certificate can take the place of the certificate in this phrase.

In this way, an authenticated signed message with the network certificate, e.g. the root certificate of the network, can be transmitted to the new component between the new component and an existing component of the network based on the device certificate and the existing device certificate of the same domain. Based on the verification using the domain root certificate of the shared domain of the new component and the existing component, authenticated messages can be transmitted between the existing component and the new component, which allow a tamper-proof transmission of the network certificate to the new component. Furthermore, such a transmission can take place in particular on the basis of a further request protection based on the root certificate of the network, in particular by means of a superlative registration authority that decides on the inclusion of the new component in the existing domain. As a result, the network certificate, usually the root certificate of the network, can be transferred to the new component in a secure and authenticated manner, so that imprinting a network certificate on the new component is possible in an automated, cost-effective, efficient and secure manner.

New components can therefore be integrated into a network, in particular a network of a system, for example in the form of emergency spare parts, without the need for manual intervention or particular specially designed additional services. In particular, the integration of new components can therefore take place without specific human actions, so that a zero-touch integration of new components can be carried out in an automated manner using the methods described herein. The prerequisite of using a network having an existing component with the existing device certificate of the domain and a new component with a device certificate of the same domain is easy to fulfill, since the domain of the device certificate and the existing device certificate is regularly determined for instance by a manufacturer of the new component and the existing component, so that the prerequisite for carrying out the method, i.e. the existence of a shared domain root certificate, is easy to fulfill by means of component management of components of the network and new components and corresponding manufacturer selection.

The phrase according to which, in the context of the present application, a device certificate is verified using the domain root certificate of the domain means that the device certificate is validated using the domain root certificate, possibly including other certificates in between, which represent a hierarchy of the PKI. This means that the validity of the device certificate is verified using the domain root certificate.

In some embodiments, the network certificate is not identical to the existing device certificate of the domain. In this development, the shared domain of the new component and the existing component is used as a trust-building tool in order to transmit the actual network certificate in a trustworthy manner.

In some embodiments, the network certificate is a root certificate of the network. In this development, a trust relationship between the new component and other or all existing components of the network can be easily established.

In some embodiments, the domain root certificate is a root certificate of the device certificate and the existing device certificate. As a result of the shared root certificate of the device certificate and the existing device certificate, the device certificate can be easily verified using the domain root certificate known to the existing device certificate. In some embodiments, the information about the domain root certificate is obtained or derived from the existing device certificate or acquired by means of the existing device certificate. In the context of the present disclosure, a root certificate of the device certificate and the existing device certificate is understood in particular as a root certificate to which the device certificate and the existing device certificate refer. In some embodiments, the device certificate and existing device certificate are signed by the device root certificate.

In some embodiments, the method is carried out by means of a registration component. In some embodiments, the registration component is part of the network into which the new component is to be integrated. However, this is not necessarily required. It is also not necessary for the new component to maintain a trusted communication relationship with the registration component itself. Rather, a trust relationship can be established between the new component and the existing component by means of the trusted communication relationship as a result of the shared domain of the device certificate and the existing device certificate. In this development, the registration component merely mediates the trusted communication relationship between the new component and the existing component. In some embodiments, there is also a trust relationship between the registration component and the existing device component, so that the registration component transmits the response from the existing component with the network certificate to the new component, e.g. again after verification.

In some embodiments, the network is a part of a system in the form of a manufacturing system or a processing system or a vehicle or a machine. Zero-touch solutions for integrating new components into a network are particularly frequently required precisely in such systems and allow a large number of network components to be connected flexibly and easily.

In some embodiments, the network is an Internet of Things network. The problem of integrating new components regularly arises especially with Internet of Things networks. In this case, the method for integrating a new component into a network offers a particularly large cost advantage.

In some embodiments, device certificate and existing device certificate and network certificate are each certificates comprising a public key of an asymmetric cryptographic key pair. In this development, authentication can be carried out using certificates in a known and established manner.

In some embodiments, a registration component incorporating teachings of the present disclosure is designed to carry out a method as described herein for integrating a new component into a network. The registration component is configured to integrate a new component with a device certificate of a domain with a domain root certificate into a network with at least one existing component of the network, wherein the existing component has an existing device certificate of the domain, wherein the registration component is configured to receive, and also to check, a request from the new component signed with the device certificate of the domain, i.e. a request signed with a private key belonging to the device certificate of the domain, and to determine the existing component with the existing device certificate and to transmit the request from the component to the existing component.

In some embodiments, the registration component is configured to receive, and also to check, a response from the existing component signed with the existing device certificate, i.e. a response signed with a private key belonging to the existing device certificate, and provided with a network certificate, preferably the root certificate of the new domain, and to transmit the response to the new component. In this way, the registration component is designed to carry out all elements of one or more of the methods described herein.

Since the registration component is configured to receive a request from the new component signed with the device certificate of the domain and to determine the existing component with the existing device certificate and to transmit the request from the component to the existing component, expediently the request from the new component can be accepted, the existing component can be determined and the request can be transmitted to the existing component by means of the registration component. The corresponding method methods described herein may therefore be carried out with the registration component.

Since the registration component is also configured to receive a response from the existing component signed with the existing device certificate and provided with a network certificate and to transmit the response to the new component, the registration component can expediently be used to provide a response signed with the existing device certificate and provided with a network certificate, which response is transmitted to the new component, and thus to enable the new component to be integrated into the network.

In some embodiments, the registration component is designed to verify the device certificate of the new component using the domain root certificate.

In some embodiments, the registration component is an Internet of Things device.

In some embodiments, a system has a network, in particular an Internet of Things network, and a registration component incorporating teachings of the present disclosure. Consequently, new components can be integrated particularly easily into the network of the system.

As shown in the FIGURE, the system ANL has an Internet of Things network ISN, and a registration component REG. The Internet of Things network ISN comprises Internet of Things devices, for example the Internet of Things device BOONEI shown, which are connected to each other via Ethernet and which are able to communicate with other, neighboring Internet of Things devices via this Ethernet. A new Internet of Things component IOTCOM is not yet part of the Internet of Things network ISN.

The new Internet of Things component IOTCOM is provided by the manufacturer with an asymmetric cryptographic key pair, wherein the public key is included in the trust domain of the manufacturer of the Internet of Things component IOTCOM by means of an X.509 certificate. This means that the Internet of Things component IOTCOM has a device certificate from a manufacturer domain. A signature made using a private key of the asymmetric cryptographic key pair of the Internet of Things component IOTCOM can be checked on the basis of a certificate chain validation using a root certificate IDEVIDCA from the manufacturer of the Internet of Things component IOTCOM.

The root certificate of the manufacturer IDEVIDCA is already known to the registration component REG as a result of an existing component previously integrated into the Internet of Things network ISN in the form of the Internet of Things device BOONEI. The registration component REG therefore stores the root certificate of the manufacturer IDEVIDCA in a memory with integrity protection.

The registration component REG is a central management component of the Internet of Things network ISN, but is not part of the Internet of Things network ISN in the exemplary embodiment shown, but may well be part of the Internet of Things network ISN in further embodiments. The registration component REG has a system root certificate LDEVIDCA, which serves as the system root certificate of the system ANL and also as the network certificate of the Internet of Things network ISN.

The new component IOTCOM, which is not yet part of the Internet of Things network ISN, is now to be integrated into the Internet of Things network ISN. To do this, the new Internet of Things component IOTCOM first initializes itself network-specifically and then sends an imprint request IMPREQ to the registration component REG. The Internet of Things component IOTCOM signs its imprint request IMPREQ with a terminal device certificate IDEVIDEE using a private key of the cryptographic key pair of the Internet of Things component IOTCOM.

The registration component REG checks the imprint request IMPREQ using the certificate chain and the known planning data of the Internet of Things network ISN of the system ANL into which the new Internet of Things component IOTCOM should be integrated. The registration component REG is able to perform the check using the certificate chain because it already knows the root certificate of the device manufacturer IDEVIDCA that is associated with the terminal device certificate IDEVIDEE.

Using the device certificate IDEVIDEE, the registration component REG determines the root certificate IDEVIDCA and identifies in the Internet of Things network ISN the Internet of Things device BOONEI that has an existing device certificate that refers to the same root certificate IDEVIDCA of the device manufacturer as the device certificate IDEVIDEE of the Internet of Things component IOTCOM. The registration component REG thus determines the Internet of Things device BOONEI as an existing component of the same manufacturer domain by means of the determination process CHESEA and transmits the imprint request IMPREQ from the Internet of Things component IOTCOM to the Internet of Things device BOONEI. The determination process CHESEA is easy for the registration component REG because the registration component REG is a central management component of the Internet of Things network ISN and knows in detail the existing device certificates of Internet of Things devices of the Internet of Things network ISN. The imprint request IMPREQ is forwarded via a security relationship established between the Internet of Things device BOONEI and the registration component REG, for example on the basis of the system-specific certificates, which is cryptographically protected.

The registration component REG requests the Internet of Things device BOONEI to create and sign an imprint response IMPRES. The Internet of Things device BOONEI creates the imprint response IMPRES and signs the imprint response IMPRES with its private key belonging to the existing device certificate IDEVIDEE. The Internet of Things device BOONEI integrates the system-specific root certificate LDEVIDCA, which is stored with integrity protection by this Internet of Things device BOONEI and previously transmitted in a trustworthy manner, into the imprint response IMPRES. The Internet of Things device BOONEI transmits its imprint response IMPRES to the registration component REG within the established security relationship. The registration component REG checks the imprint response IMPRES if necessary and sends the imprint response IMPRES as part of a new imprint response to the Internet of Things component IOTCOM.

The Internet of Things component IOTCOM can check the imprint response IMPRES by means of a certificate chain validation using the device manufacturer's own root certificate IDEVIDCA with a check step CHE. Since the Internet of Things device BOONEI is located in the same manufacturer domain of the device manufacturer, the signature verification by the Internet of Things component IOTCOM is successful and the system certificate LDEVIDCA contained in the message is recognized as trustworthy by the new Internet of Things component IOTCOM and stored in an integrity-protected memory.

The new Internet of Things component IOTCOM can use this system-specific root certificate after the trusted root certificate LDEVIDCA has been received in order to establish a new security relationship with the registration component REG. Within such a new security relationship with the registration component REG, for instance, a system-specific device certificate LDEVIDEE can be rolled out for the new Internet of Things component IOTCOM.

Between the imprint request IMPREQ and the imprint response IMPRES, the new Internet of Things component IOTCOM does not accept any other message.

In the event that the registration component REG does not find an existing component with an existing component certificate for the manufacturer domain, the new Internet of Things component IOTCOM cannot be authenticated and verified as trustworthy by existing components of the Internet of Things network ISN, an exception procedure takes place. In this exception procedure, system-specific root certificates LDEVIDCA can be introduced after a possible manual check of IOTCOM in an organizationally protected environment.

In some embodiments, it is possible that the communication relationship between the new Internet of Things component IOTCOM and the registration component REG, which is used for the imprint request IMPREQ, is provisionally accepted as trustworthy. Within such a provisional trust relationship, the new Internet of Things component IOTCOM initially only provisionally accepts a mutually authenticated communication, which cannot be finally validated due to a missing root certificate LDEVIDCA for the new Internet of Things component IOTCOM, and decides after processing the imprint response IMPRES whether this security relationship is to be maintained or whether it must be rolled back. The system-specific root certificate LDEVIDCA contained in the imprint response IMPRES is used for this decision. In this development of the invention, no old imprint response IMPRES or imprint response IMPRES not transmitted by the actual registration component REG can be forced on the new Internet of Things component IOTCOM. In further exemplary embodiments not specifically shown, nonces are used in the various imprint requests IMPREQ and in the imprint response IMPRES to achieve in each case unique imprint requests and imprint responses.

What is claimed is:

1. A method for integrating a new component with a device certificate of a domain with a domain root certificate into a network with at least one existing component with an existing device certificate of the domain, the method comprising:
accepting a request from the new component signed with the device certificate of the domain;
determining the existing component with the existing device certificate
transmitting the request to the existing component;
verifying the device certificate using the domain root certificate of the domain;
providing a response signed with the existing device certificate and provided with a network certificate using the existing component or obtaining a response signed with the existing device certificate and provided with a network certificate from the existing component;
transmitting the response to the new component; and
integrating the new component into the network using the network certificate.

2. The method as claimed in claim 1, wherein the network certificate comprises a root certificate of the network.

3. The method as claimed in claim 1, wherein the domain root certificate comprises a root certificate of the device certificate and the existing device certificate.

4. The method as claimed in claim 1, carried out using a registration component.

5. The method as claimed in claim 1, wherein the registration component is not part of the network and is configured for communication with components of the network.

6. The method as claimed in claim 1, wherein the registration component maintains a trust relationship with the existing component.

7. The method as claimed in claim 1, wherein the network is a part of a manufacturing system or a processing system or a vehicle or a machine.

8. The method as claimed in claim 1, wherein the network comprises an Internet of Things network.

9. The method as claimed in claim 1, wherein the device certificate and existing device certificate and the network certificate are each certificates comprising a public key part of an asymmetric cryptographic key pair.

10. A registration component to integrate a new component having a device certificate of a domain with a domain root certificate into a network with an existing component having an existing device certificate of the domain, the registration component comprising:
a communication connection to receive a request from the new component signed with the device certificate of the domain; and
a processor to identify the at least one existing component with the existing device certificate and to transmit the request from the new component to the existing component; and
wherein the communication connection receives a response from the existing component signed with the existing device certificate and provided with a network certificate; and
the processor transmits the response to the new component.

11. The registration component as claimed in claim 10, wherein the processor is further configured to verify the device certificate of the new component using the domain root certificate.

12. The registration component as claimed in claim 10, which is an Internet of Things device.

13. (canceled)
